(19) United States
(12) Patent Application Publication
(10) Pub. No.: US 2016/0339565 A1
(43) Pub. Date: Nov. 24, 2016

(54) METHOD FOR MAKING DRIVER BIT

(71) Applicant: Tuo-Jen Chen, Taichung (TW)

(72) Inventor: Tuo-Jen Chen, Taichung (TW)

(21) Appl. No.: 14/715,600

(22) Filed: May 19, 2015

(51) Int. Cl. B25B 15/00; B23P 15/00

(52) U.S. Cl. CPC B25B 15/001; B23P 15/00

(57) ABSTRACT

A method for making a driving bit includes a step of preparing a bar; a step of rounding the pre-connection end; a step of forming a connection end; a step of forming a transition section, a step of forming a driving end, and a step of obtaining a driving bit. Surplus material is removed from the pre-connection end to form the connection end which includes two side faces and two contact faces which contacts a reception tool. The distance between the two contact faces is X, the distance between the two side faces is Y, and X≧1.2Y. The driving bit made by the method has light weight and small volume.

### BACKGROUND OF THE INVENTION

1. Fields of the Invention

The present invention relates to a method for making a driving bit which is compact, light and saves storage space.

2. Descriptions of Related Art

The conventional driver bit 10 is disclosed in FIGS. 1 and 2, and comprises a driving end 11 and a connection end 12, and a neck 13 is connected between the driving end 11 and a connection end 12. The driving end 11 is used to drive a bolt 14 which has a head 141 with a recess 142 which has different shapes, such as a hexagonal recess or a polygonal recess, so as to receive the driving end 11 therein. The connection end 12 is to be connected with a reception hole 151 of a tool 15 which may also be driven electrically. The driving end 11 rotates the bolt 14 to tighten or loosen the bolt 14.

The reception hole 151 generally is a hexagonal hole of 6.35 mm, so that all of the connection ends 12 of the driving bits 10 have to be designed to be matched with the hexagonal hole of 6.35 mm, while the driving end 11 can have different shapes.

However, the connection end 12 occupies a certain space so that when packing the driving bits 10 in a box, the connection ends 12 located side by side occupy a lot of space. The fixed shape and size of the connection ends 12 of the driving bits 10 are heavy and not benefit for storage.

In order to improve the shortcoming mentioned above, as shown in FIGS. 3 and 4, the driving bit 10 has a hollow portion 101 defined in the head thereof so as to reduce the weight. Even if the hollow portion 101 does not affect the structural strength of the driving bit 10, the space does not change and occupies the same space. The hollow portion 101 requires extra machining steps and cost.

FIGS. 5 and 6 show the conventional tool boxes 161, 162 which have many reception compartments 163, 164 for receiving the driving bits 10. Nevertheless, the more reception compartments 163, 164 are provided, the more driving bits 10 means more weight is added. For the users, the more driving bits 10 he/she carries, the more burden of weight is applied.

A hand tool 17 as disclosed in FIG. 8 shows that the handle has a space 171 defined therein and multiple compartments 172 are formed to receive driving bits 10 therein. This hand tool 17 cannot improve the inherent shortcoming of the fixed shape of the connection end of the driving bit 10. Besides, the heavy handle of the hand tool 17 is not convenient for the user to operate.

FIGS. 9 and 10 show that the driving bits 18, 19 each have a distinguishable portion 181/191 which intends to attract the users to purchase and show the difference from the conventional driving bits. Again, the problem of the fixed shape of the connection end is not improved. Besides, the distinguishable portion 181, 191 can be formed by different methods such as electric coating, plastic injection molding or shrinking film, these extra steps increase manufacturing cost. Furthermore, as shown in FIG. 9, each of the driving bits 18 has to form a recessed groove in which the distinguishable portion 181 is formed therein. This is difficult to complete when forming the distinguishable portion 181 to the recessed groove. The recessed groove is defined in each of the six sides of the driving bits 18, 19 so as to form the distinguishable portion 181, 191. The difficulty is obvious, and the fixed shape of the connection end is not improved.

FIGS. 11 and 12 show the method for making the conventional driving bits 10 and comprises:

a step of preparing: an elongate bar with a desired length being prepared;

a step of forming: forming the bar to have a hexagonal cross section;

a step of cutting: cutting the bar into sections with desired length of a driving bit 10;

a step of lathing: lathing multiple notches 121 in the connection end 12 of the driving bit 10 and lathing the connection end 12 to have rounded portion 122;

a step of shaping: shaping the front end of the driving bit 10 into a desired outer diameter, and

a step of forming the driving end: forming the driving end 11 of the driving bit 10 into desired shape such as the shape disclosed in FIG. 12.

There are too many steps involved to make the driving bit 10, and significant material is wasted during the steps. Manufacturing deficiencies are found frequently. The weight and the shape of the connection end of the conventional driving bits are not improved.

The present invention intends to provide a method for making a driving bit and the method eliminates the shortcomings mentioned above.

### SUMMARY OF THE INVENTION

The present invention relates to a method for making a driving bit, and comprises:

a step of preparing: preparing a bar with a pre-set length;

a step of rounding: setting a first end of the bar to be a pre-connection end and a second end of the bar to be a pre-driving end, the pre-connection end being rounded to form a rounded surface;

a step of forming a connection end: removing surplus material from the pre-connection end to form the connection end which includes two side faces and two contact faces which are adapted to be in contact with a reception tool, a distance between the two contact faces being defined as X, a distance between the two side faces being defined as Y, wherein X≧1.2Y;

a step of forming a transition section: lathing the pre-driving end to form the transition section;

a step of forming a driving end: milling and cutting a front end of the transition section to form the driving end which is adapted to drive tools, an outer maximum diameter of the driving end being defined as Z, wherein Y≧0.5Z, and

a step of obtaining a product: a driving bit being obtained.

The present invention provides a second embodiment of the method for making a driving bit, and comprises:

a step of preparing: preparing an elongate bar with a polygonal cross section, the bar having two side faces and two contact faces which are adapted to be in contact with at least two insides of a hexagonal recess of a reception tool, a distance between the two contact faces being defined as X1, a distance between the two side faces being defined as Y1, wherein X1≧1.2Y1;

a step of rounding and forming a connection end: setting a first end of the bar to be a pre-connection end and a second end of the bar to be a pre-driving end, the pre-connection end being rounded to form a rounded surface;

a step of forming a transition section: lathing the pre-driving end to form the transition section;

a step of forming a driving end: milling and cutting a front end of the transition section to form the driving end which is adapted to drive tools,

a step of obtaining a product: a driving bit being obtained.

The present invention provides a third embodiment of the method for making a driving bit of 50 mini-meter long, and comprises:

a step of preparing: preparing an elongate bar with a polygonal cross section, the bar having two side faces and two contact faces which are adapted to be in contact with at least two insides of a hexagonal recess of a reception tool, a distance between the two contact faces being defined as X2, a distance between the two side faces being defined as Y2, wherein X2≧1.2Y2;

a step of rounding and forming a connection end: setting a first end of the bar to be a pre-connection end and a second end of the bar to be a pre-driving end, the pre-connection end being rounded to form a rounded surface;

a step of forming a driving end: milling and cutting a front end of the pre-driving end to form the driving end is adapted to drive tools, and

a step of obtaining a product: a driving bit being obtained.

Preferably, multiple notches are defined in the pre-connection end 53 during the second step of each of the methods mentioned above.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the conventional driving bit;

FIG. 2 shows the conventional driving bit, a bolt and a tool;

FIG. 3 is a perspective view to show another conventional driving bit;

FIG. 4 is a cross sectional view of the conventional driving bit in FIG. 3;

FIG. 5 shows the conventional driving bit and a tool box;

FIG. 6 shows the conventional driving bits and another tool box;

FIG. 7 is a cross sectional view to show that the conventional driving bits are received in the tool box in FIG. 6;

FIG. 8 shows a conventional hand tool and the conventional driving bits are received in the handle of the hand tool;

FIG. 9 shows that the conventional driving bit has a distinguishable portion;

FIG. 10 shows that the conventional driving bit has another type of the distinguishable portion;

FIG. 11 illustrates the steps of the conventional method to make the conventional driving bit;

FIG. 12 shows the conventional driving bit made by the method in FIG. 11;

FIG. 13 shows the block diagram to show the steps of the first embodiment of the method of the present invention;

FIG. 14 illustrates the first step of the first embodiment of the method of the present invention;

FIG. 15 illustrates the second step of the first embodiment of the method of the present invention;

FIG. 16 illustrates the third step of the first embodiment of the method of the present invention;

FIG. 17 is an end cross sectional view of the driving bit in FIG. 16;

FIG. 18 illustrates the fourth step of the first embodiment of the method of the present invention;

FIG. 19 illustrates the fifth step of the first embodiment of the method of the present invention;

FIG. 20 shows the driving bit made by the first embodiment of the method of the present invention;

FIG. 21 is an end cross sectional view to show the saved space when engaging the driving bit of the present invention in a tool;

FIG. 22 shows the block diagram to show the steps of the second embodiment of the method of the present invention;

FIG. 23 illustrates the first step of the second embodiment of the method of the present invention;

FIG. 24 is an end cross sectional view to show the saved space when engaging the driving bit made by the second embodiment of the method of the present invention in a tool;

FIG. 25 illustrates the second step of the second embodiment of the method of the present invention;

FIG. 26 illustrates the third step of the second embodiment of the method of the present invention;

FIG. 27 shows the block diagram to show the steps of the third embodiment of the method of the present invention;

FIG. 28 illustrates the first step of the third embodiment of the method of the present invention;

FIG. 29 is an end cross sectional view to show the saved space when engaging the driving bit made by the third embodiment of the method of the present invention in a tool;

FIG. 30 illustrates the first step of the third embodiment of the method of the present invention;

FIG. 31 illustrates the second step of the third embodiment of the method of the present invention, and

FIG. 32 illustrates the third step of the third embodiment of the method of the present invention.

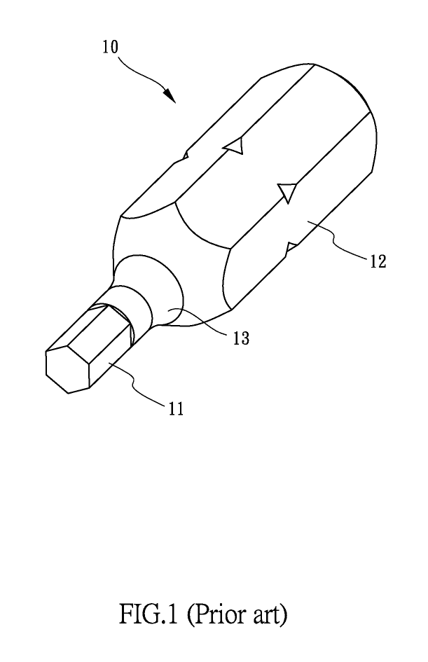

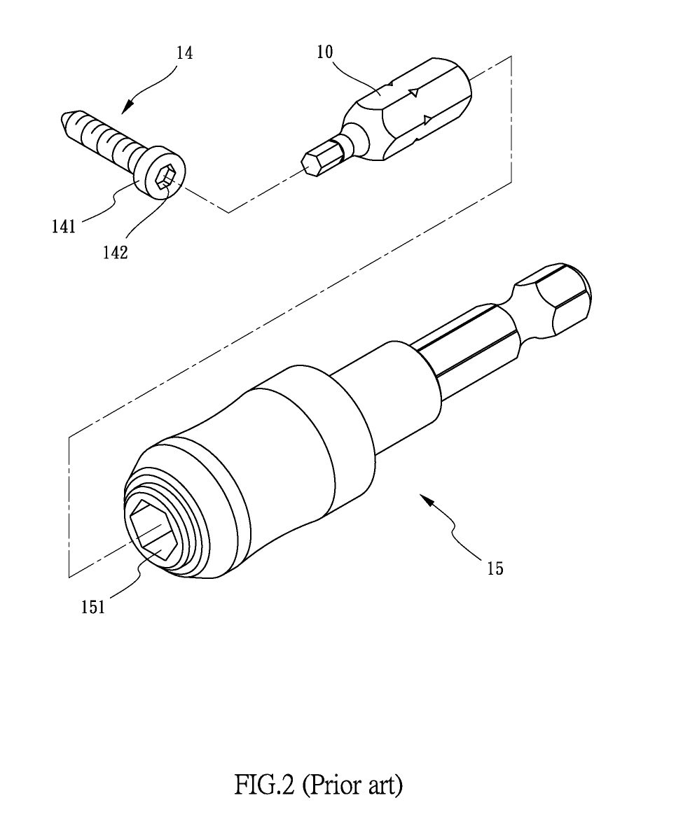

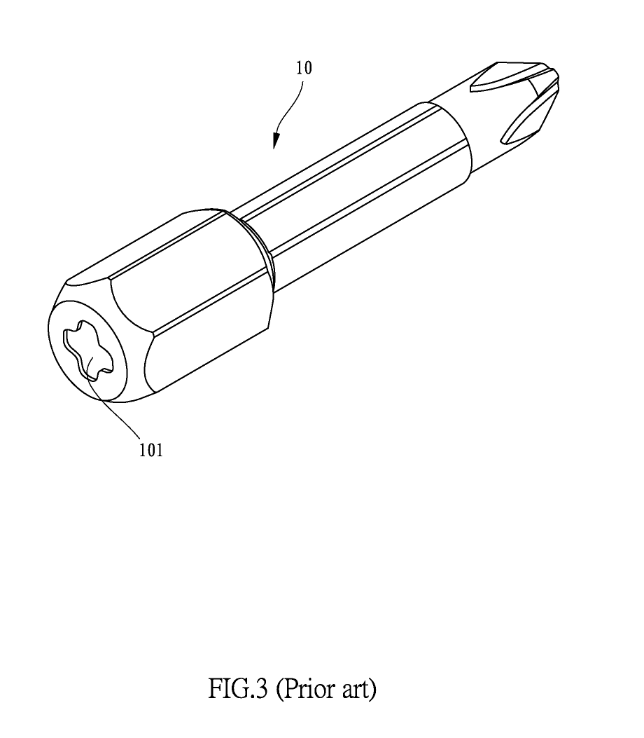

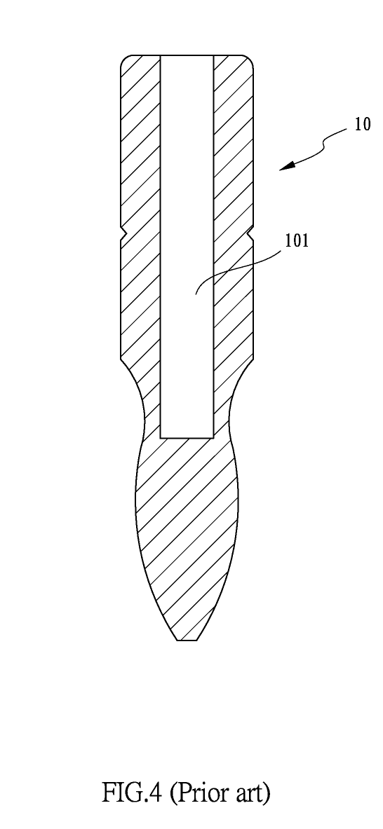

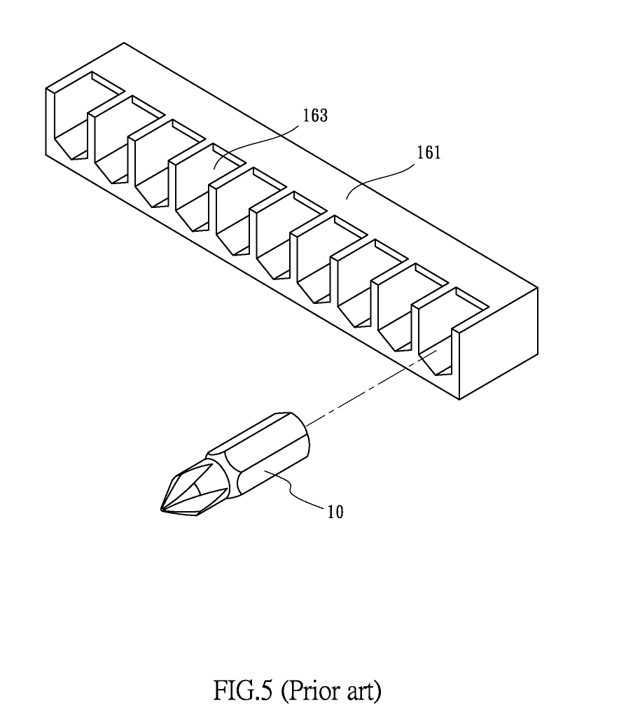

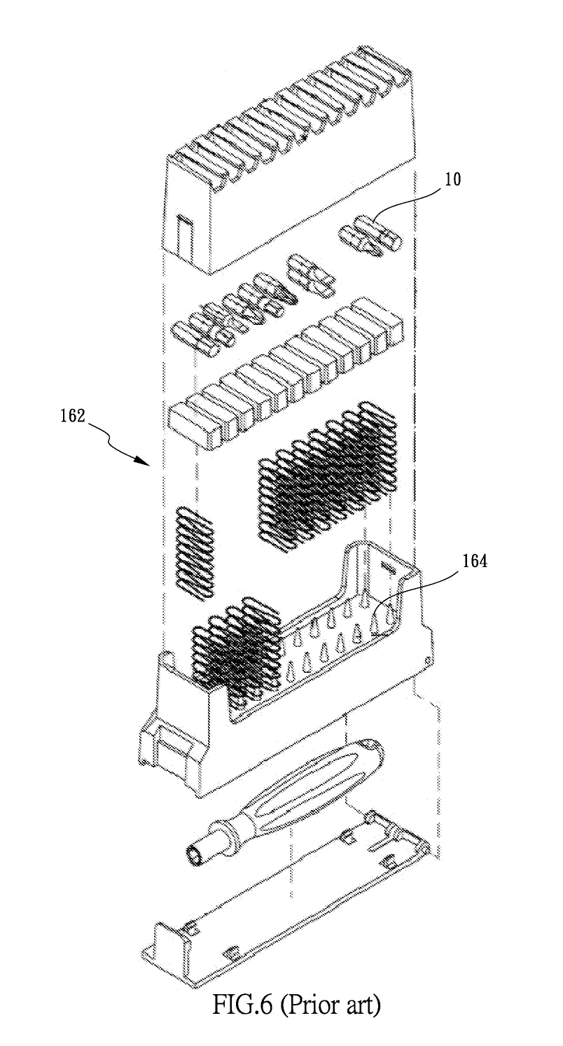

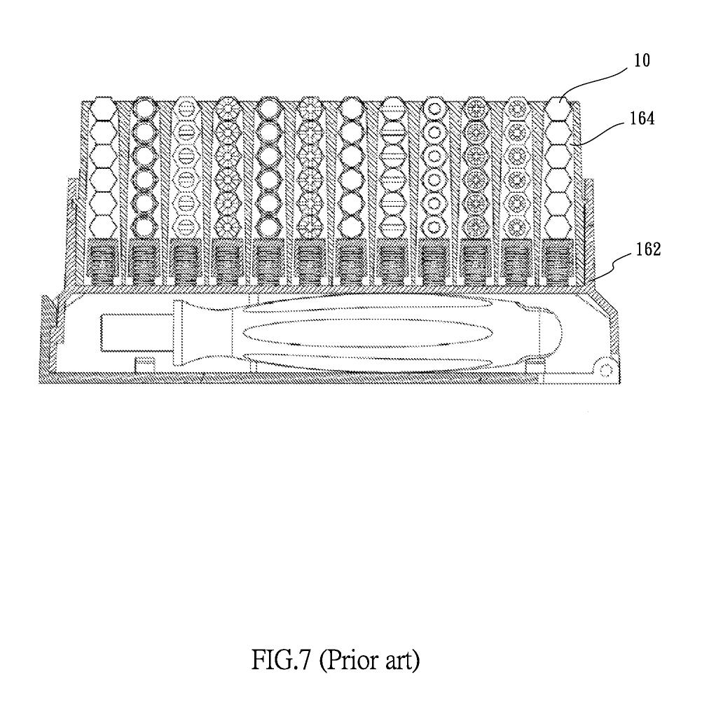

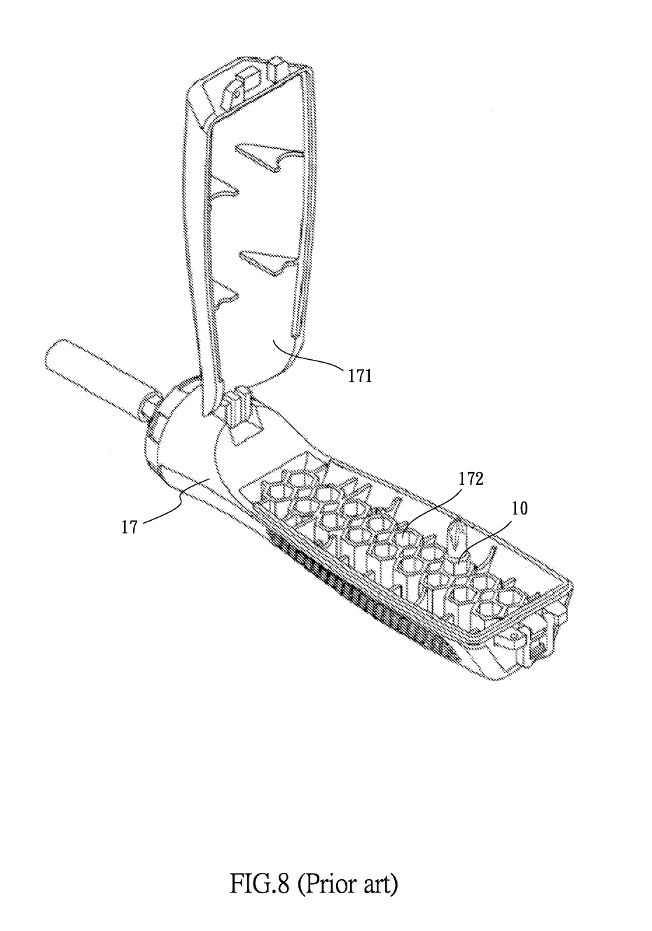

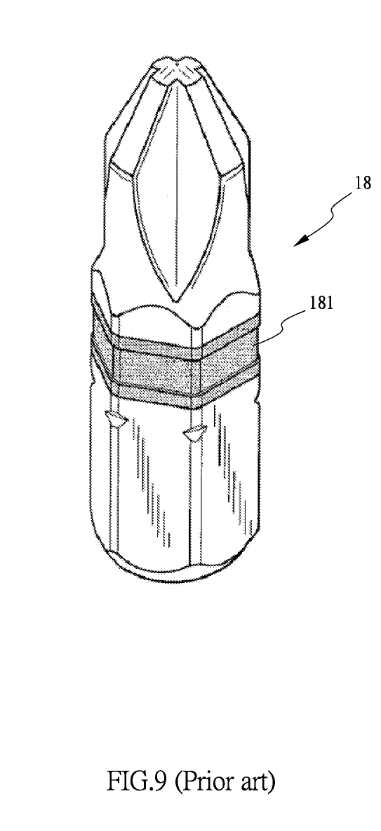

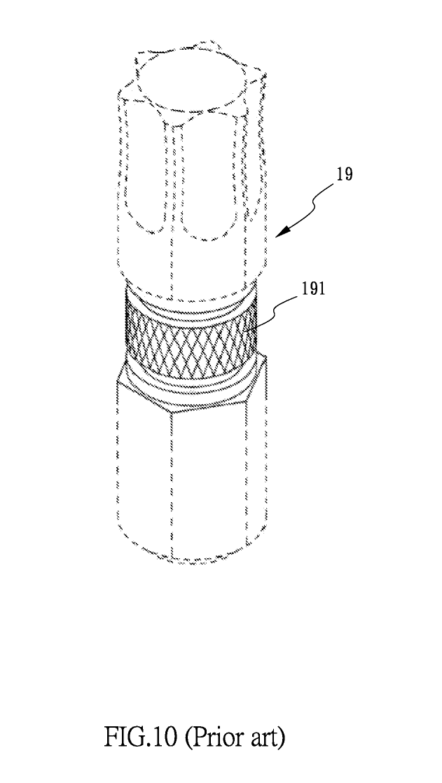

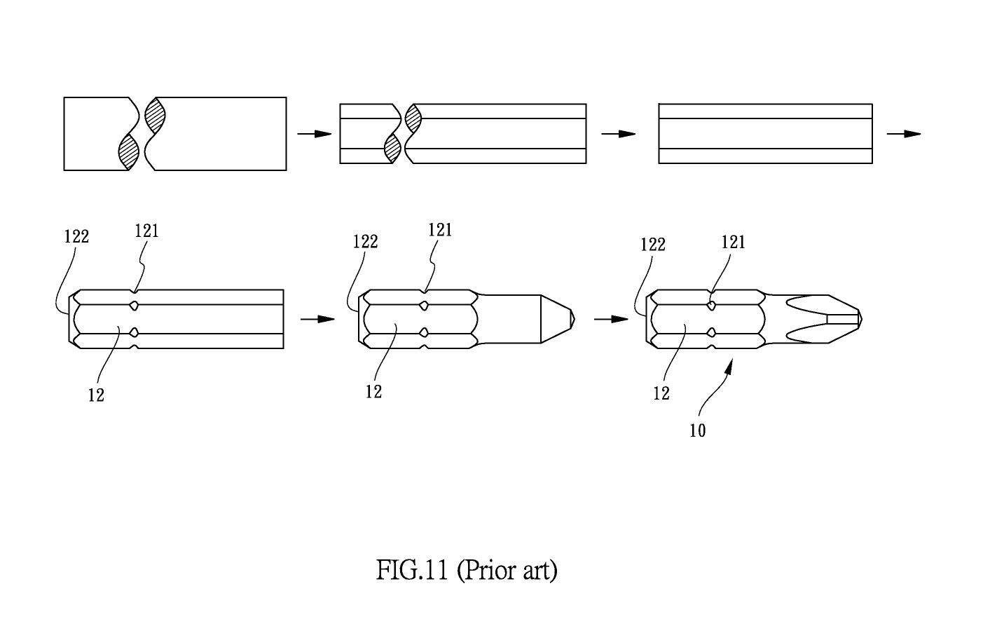

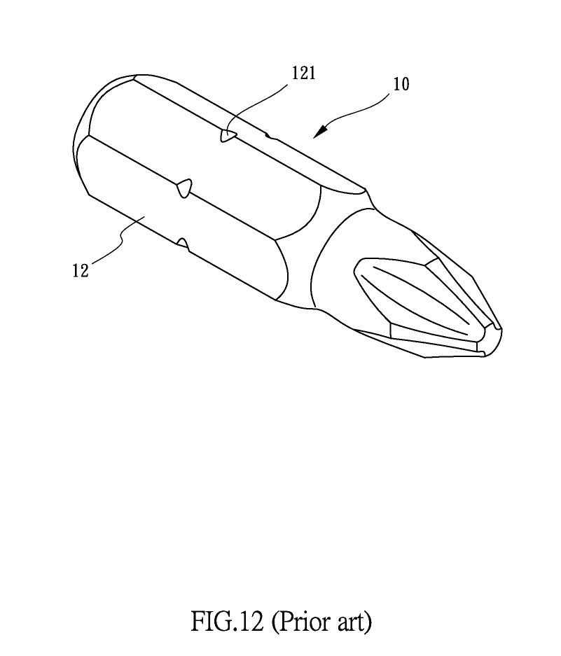

### DETAILED DESCRIPTION OF THE PREFERRED EMBODIMENT

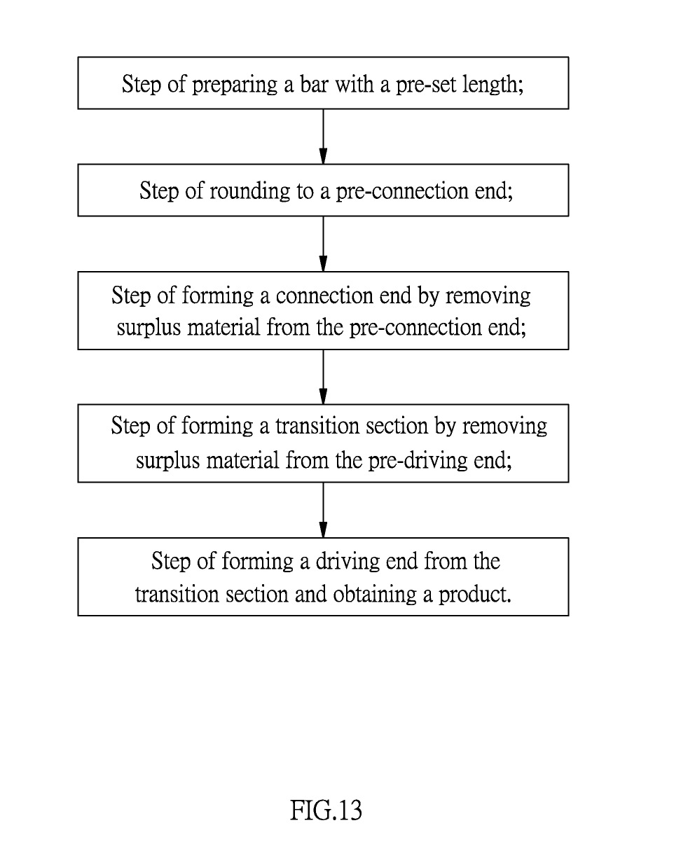

Referring to FIG. 13, the first embodiment of the method of the present invention comprises the following steps.

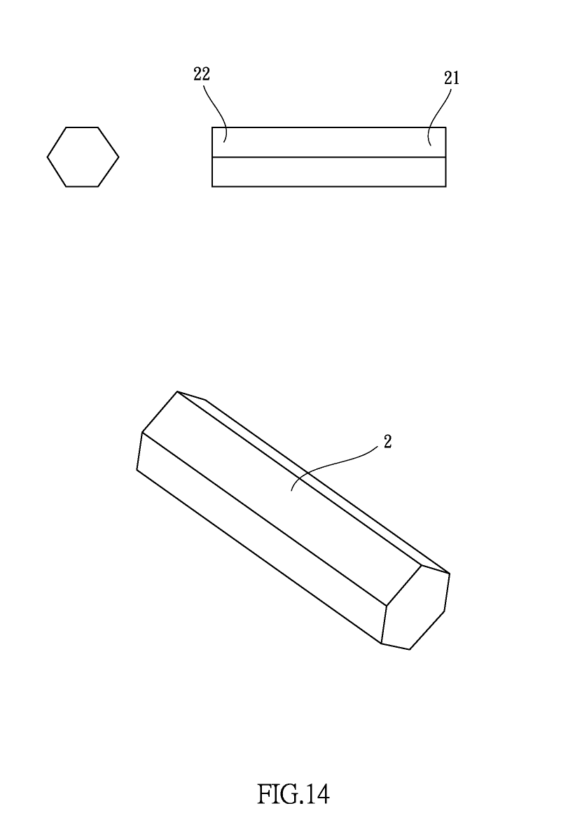

A step of preparing. A bar 2 with a pre-set length is prepared. The bar 2 has a hexagonal cross section as shown in FIG. 14.

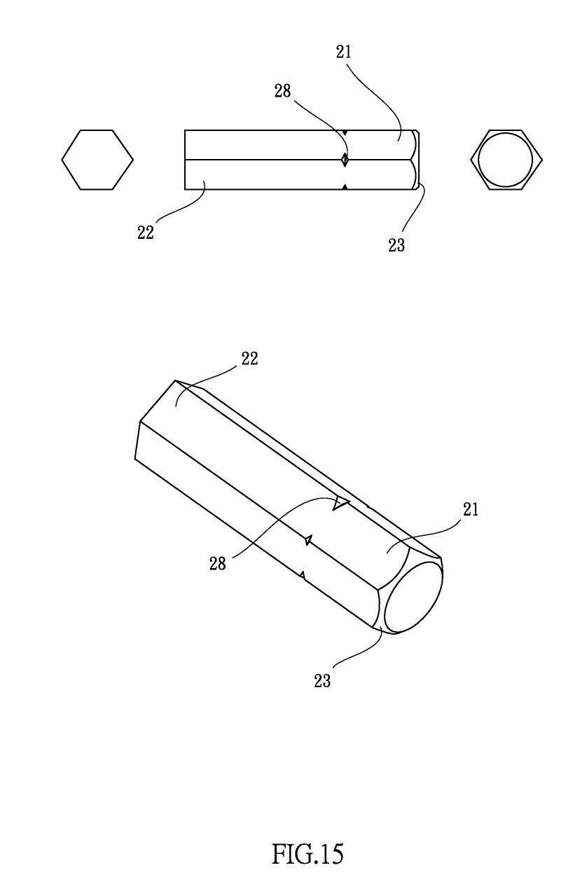

A step of rounding. A first end of the bar 2 is set to be a pre-connection end 21 and a second end of the bar 2 is set to be a pre-driving end 22. The pre-connection end 21 is rounded to form a rounded surface 23 as shown in FIGS. 14 and 15.

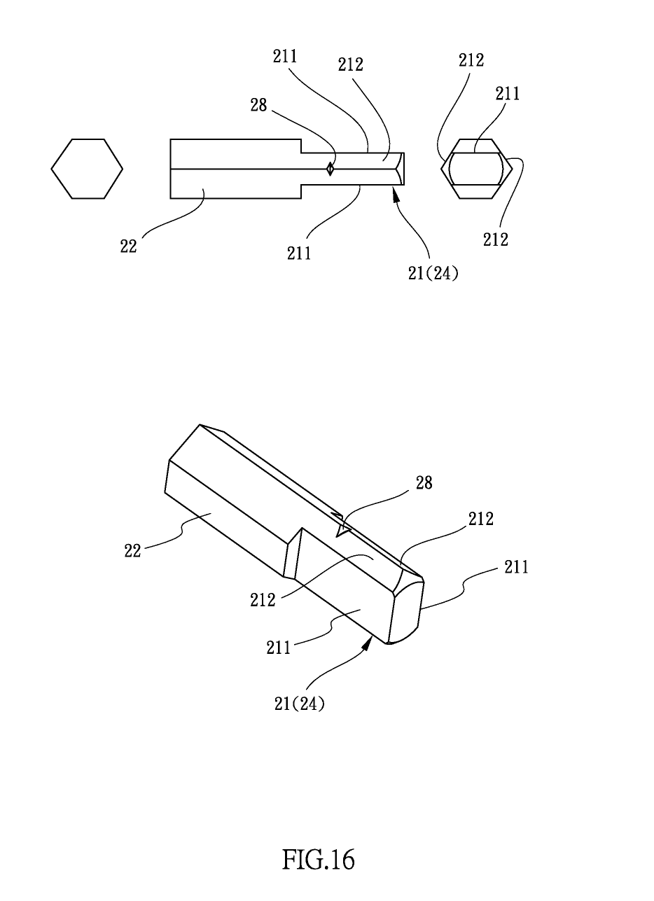

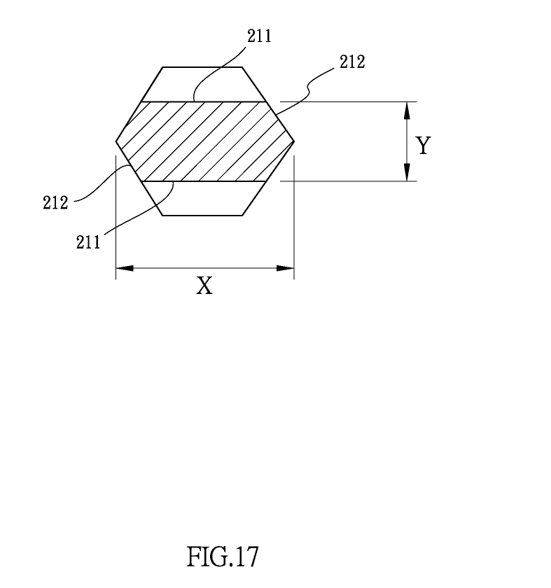

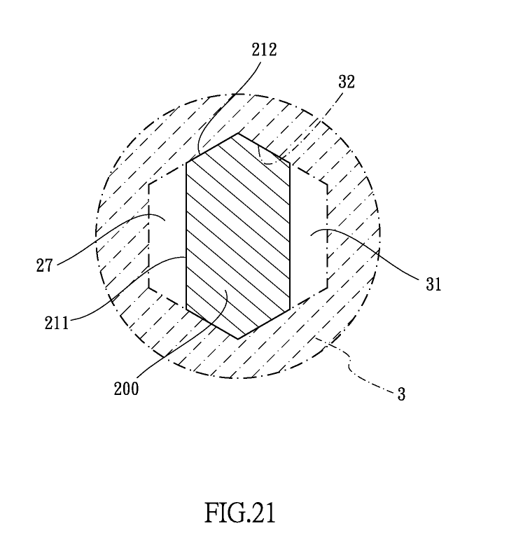

A step of forming a connection end. The surplus material is removed from the pre-connection end 21 as shown in FIG. 16, to form the connection end 24 which includes two side faces 211 and two contact faces 212 which are in contact with at least two insides 32 of a hexagonal recess 31 of a reception tool 3. As shown in FIG. 21, each contact face 212 includes two inclined faces, all of the four inclined faces contact four insides 32 of the hexagonal recess 31 of the reception tool 3. The connection end 24 is an elongate end as shown in FIG. 17, wherein the distance between the two respective peaks of the two contact faces 212 is defined as X, and the distance between the two side faces 211 is defined as Y, wherein X≧1.2Y.

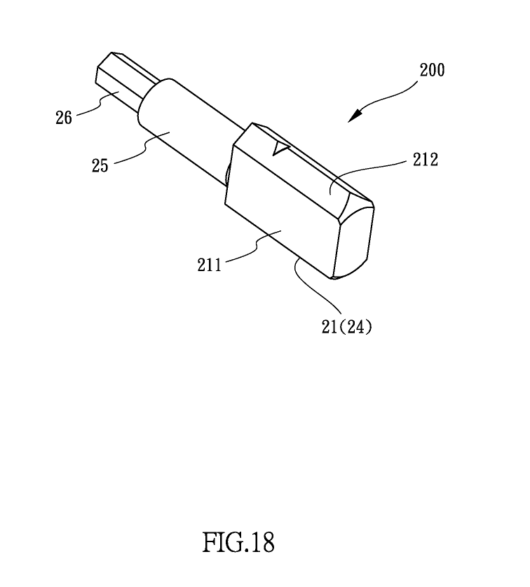

A step of forming a transition section. The pre-driving end 22 is lathed to form the transition section 25 as shown in FIG. 18.

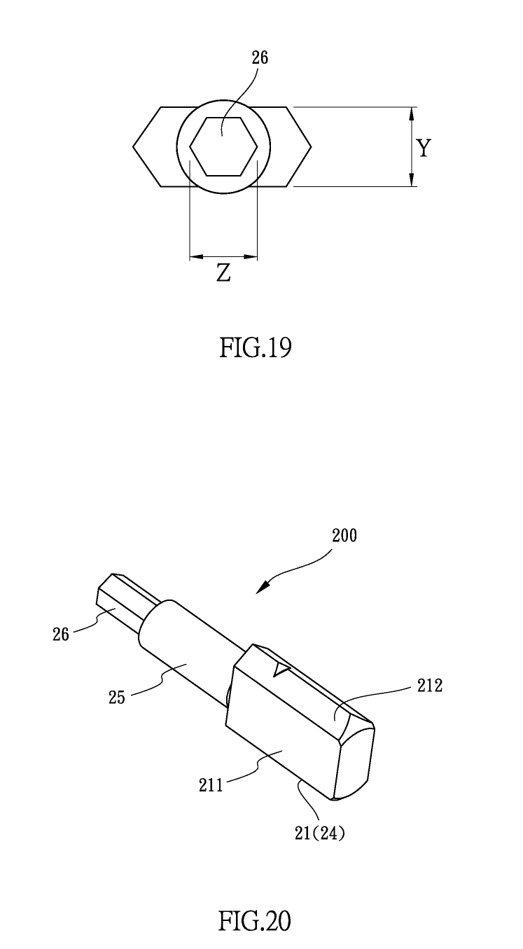

A step of forming a driving end. The front end of the transition section 25 is milled and cut to form the driving end 26 which is used to drive tools. The outer maximum diameter of the driving end 26 is defined as Z, wherein Y≧0.5Z as shown in FIG. 19.

A step of obtaining a product. The driving bit 200 is then obtained as shown in FIG. 20.

It is noted that each contact face 212 of the driving bit 200 includes two inclined faces, and all of the four inclined faces contact four insides 32 of the hexagonal recess 31 of the reception tool 3 so that the driving bit 200 is effectively driven by the tool 3.

The condition of X≧1.2Y makes the connection end 24 be a compact and small end while the sufficient strength is maintained. As shown in FIG. 21, significant saved space 27 is saved when being cooperated with the hexagonal recess of the tool.

The side faces 211 are large and obvious so that the side faces 211 can be easily applied with distinguishable portion.

The contact faces 212 of the connection end 24 allow the driving bit 200 to be cooperated with the existed tool 3 with a hexagonal recess 31.

The connection end 24 is slimmer than the conventional driving bit so that the weight of the driving bit 200 is reduced effectively. No hollow portion needs to be made so that the strength is better than those with the hollow portion. The users do not feel heavy when carrying the driving bits 200 of the present invention;

The condition of Y≧0.5Z makes the driving end 26 maintains the necessary strength for the driving end 26.

Preferably, multiple notches 28 are defined in the pre-connection end 21 during the step of rounding.

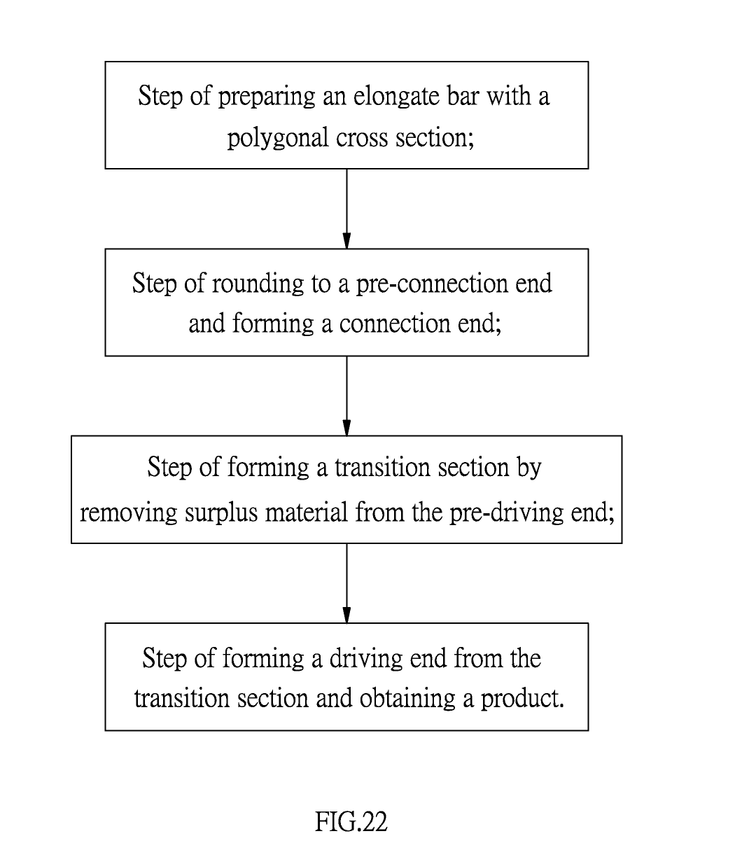

FIG. 22 shows the second embodiment of the present invention which comprises the following steps.

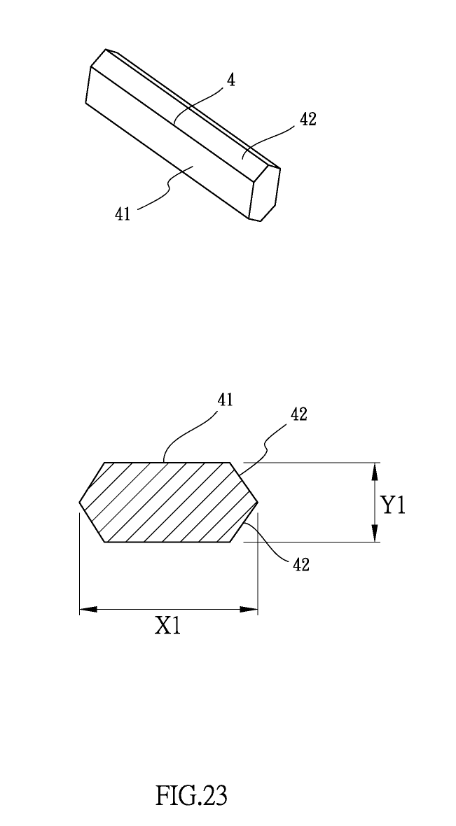

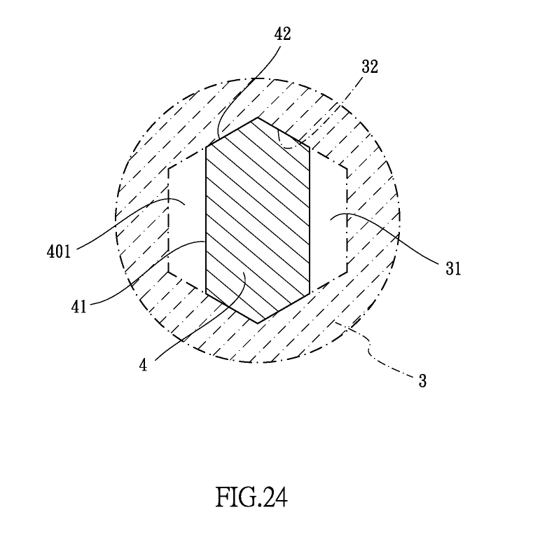

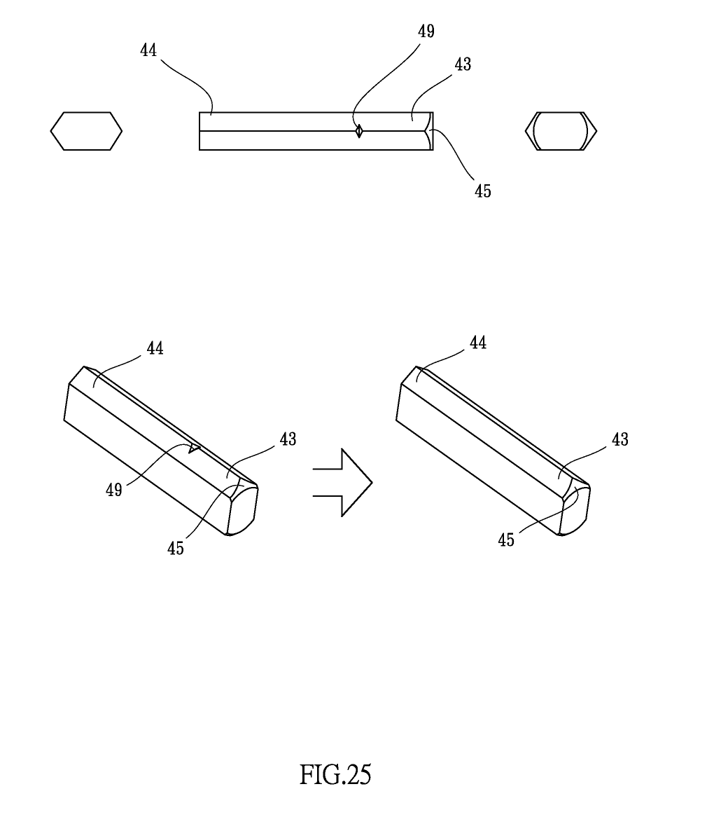

A step of preparing. An elongate bar 4 with a polygonal cross section is prepared. The bar 4 has two side faces 41 and two contact faces 42 which are in contact with at least two insides of a hexagonal recess 31 of a reception tool 3. As shown in FIGS. 23 and 24, each contact face 42 includes two inclined faces, all of the four inclined faces contact four insides 32 of the hexagonal recess 31 of the reception tool 3. The distance between the two respective peaks of the contact faces 42 is defined as X1, and the distance between the two side faces 41 is defined as Y1, wherein X1≧1.2Y1.

A step of rounding and forming a connection end. The first end of the bar 4 is set to be a pre-connection end 43 and the second end of the bar 4 is set to be a pre-driving end 44. The pre-connection end 41 is rounded to form a rounded surface 45.

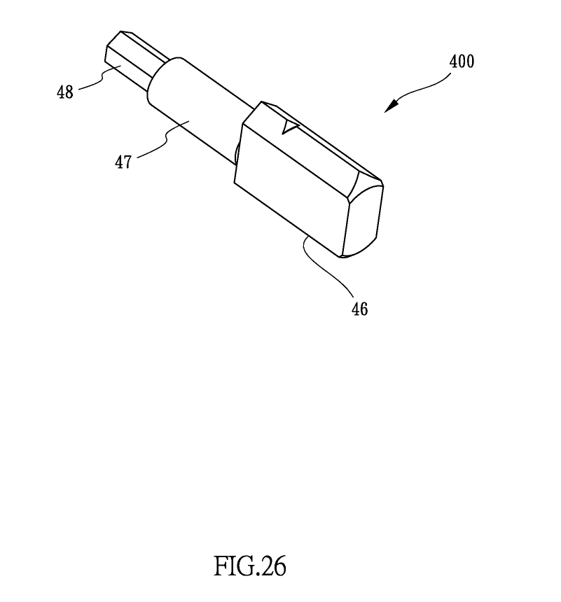

A step of forming a transition section. The pre-driving end 44 is lathed to form the transition section 47 as shown in FIG. 26.

A step of forming a driving end. The front end of the transition section 47 is milled and cut to form the driving end 48 which is used to drive tools as shown in FIG. 26.

A step of obtaining a product. The driving bit 400 of the present invention is then obtained.

Preferably, multiple notches 49 are defined in the pre-connection end 43 during the step of rounding and forming a connection end.

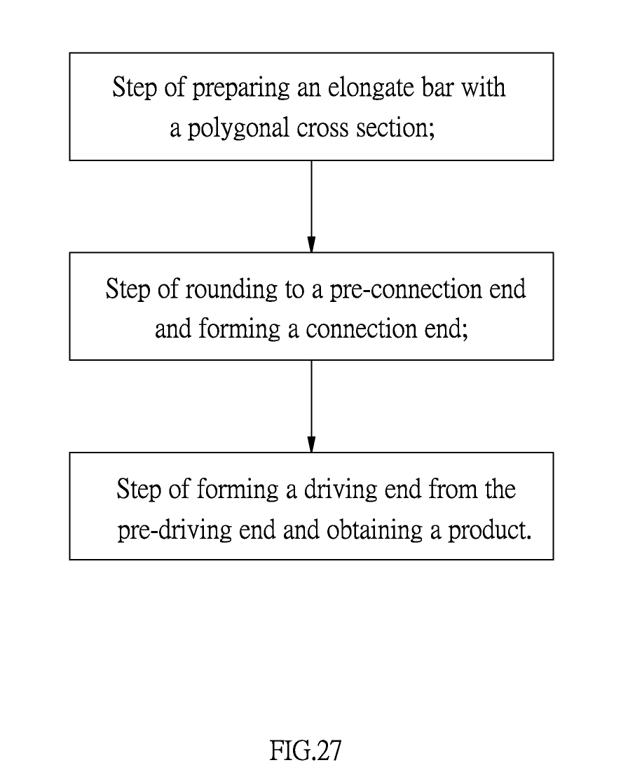

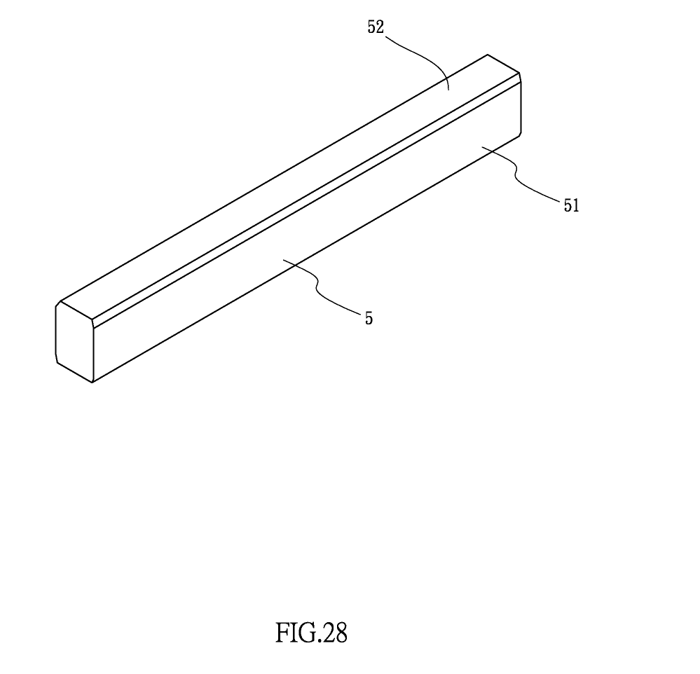

FIG. 27 shows the third embodiment of the method of the present invention, wherein the method is specifically for making a driving bit of 50 mini-meter long, and the method comprises the following steps.

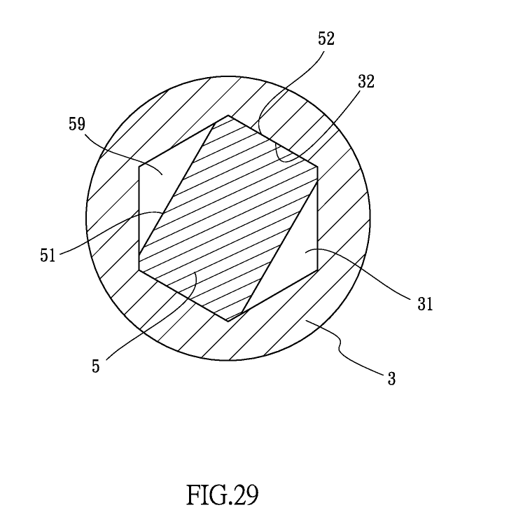

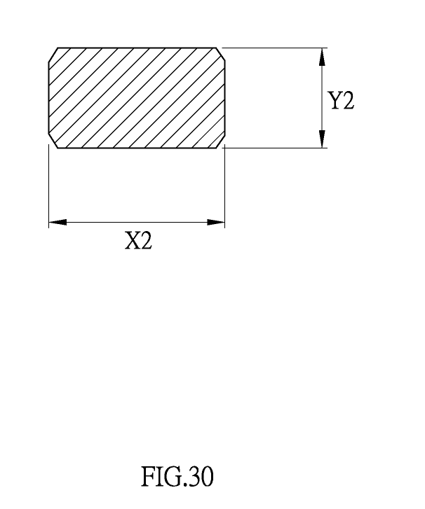

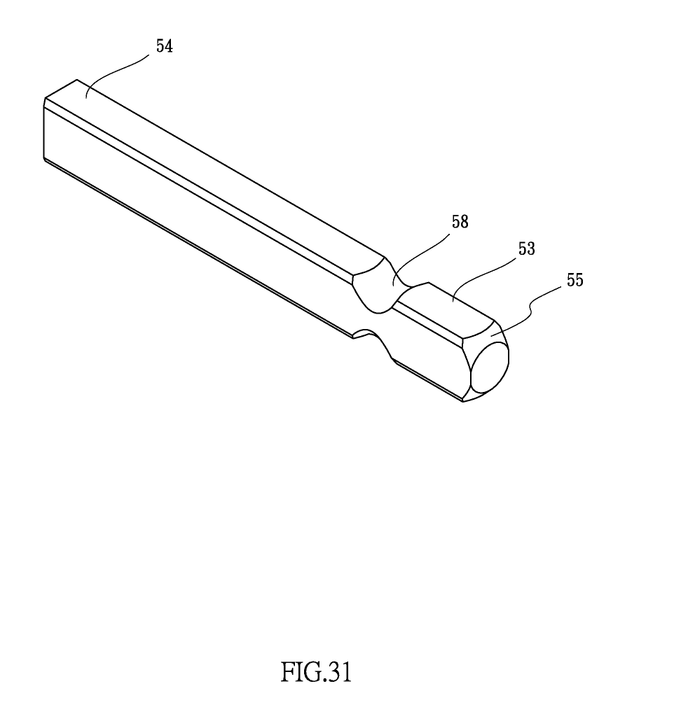

A step of preparing. An elongate bar 5 with a polygonal cross section is prepared. The bar 5 has two side faces 51 and two contact faces 52 which are to be in contact with at least two insides 32 of a hexagonal recess 31 of a reception tool 3. As shown in FIG. 29, each contact face 42 includes two inclined faces, all of the four inclined faces contact four insides 32 of the hexagonal recess 31 of the reception tool 3. The distance between the two contact faces 52 is defined as X2, and the distance between the two side faces 51 is defined as Y2, wherein X2≧1.2Y2 as shown in FIG. 30.

A step of rounding and forming a connection end. The first end of the bar 5 is set to be a pre-connection end 53 and the second end of the bar 5 is set to be a pre-driving end 54. The pre-connection end 51 is rounded to form a rounded surface 55 so as to form the connection end 56.

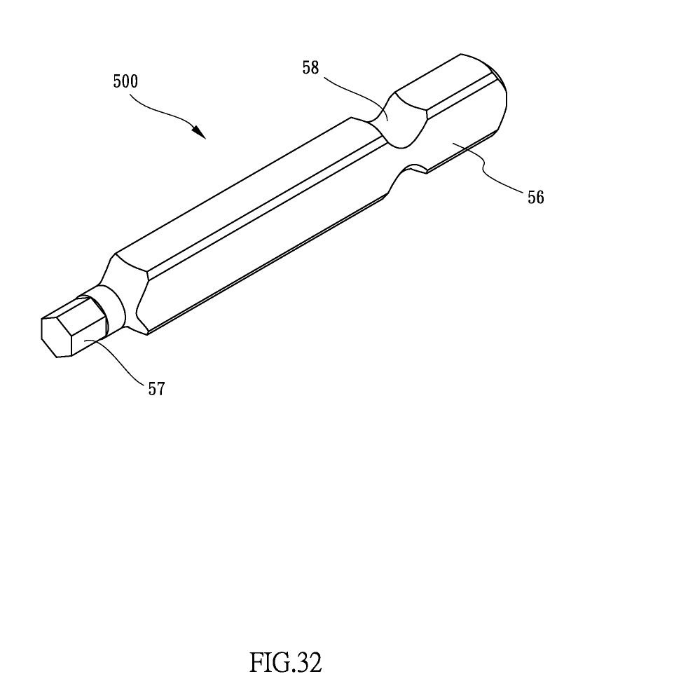

A step of forming a driving end. The front end of the pre-driving end 54 is milled and cut to form the driving end 57 is used to drive tools as shown in FIG. 32.

A step of obtaining a product. The driving bit 500 is then obtained.

Preferably, multiple notches 58 are defined in the pre-connection end 53 during the step of rounding and forming a connection end.

While we have shown and described the embodiment in accordance with the present invention, it should be clear to those skilled in the art that further embodiments may be made without departing from the scope of the present invention.

What is claimed is:

1. A method for making a driving bit, comprising:
a step of preparing: preparing a bar with a pre-set length;
a step of rounding: setting a first end of the bar to be a pre-connection end and a second end of the bar to be a pre-driving end, the pre-connection end being rounded to form a rounded surface;
a step of forming a connection end: removing surplus material from the pre-connection end to form the connection end which includes two side faces and two contact faces which are adapted to be in contact with a reception tool, a distance between the two contact faces being defined as X, a distance between the two side faces being defined as Y, wherein X≧1.2Y;
a step of forming a transition section: lathing the pre-driving end to form the transition section;
a step of forming a driving end: milling and cutting a front end of the transition section to form the driving end which is adapted to drive tools, an outer maximum diameter of the driving end being defined as Z, wherein Y≧0.5Z, and
a step of obtaining a product: a driving bit being obtained.

2. The method as claimed in claim 1, wherein multiple notches are defined in the pre-connection end during the step of rounding.

3. A method for making a driving bit, comprising:
a step of preparing: preparing an elongate bar with a polygonal cross section, the bar having two side faces and two contact faces which are adapted to be in contact with at least two insides of a hexagonal recess of a reception tool, a distance between the two contact faces being defined as X1, a distance between the two side faces being defined as Y1, wherein X1≧1.2Y1;
a step of rounding and forming a connection end: setting a first end of the bar to be a pre-connection end and a second end of the bar to be a pre-driving end, the pre-connection end being rounded to form a rounded surface so as to form the connection end;
a step of forming a transition section: lathing the pre-driving end to form the transition section;
a step of forming a driving end: milling and cutting a front end of the transition section to form the driving end which is adapted to drive tools,
a step of obtaining a product: a driving bit being obtained.

4. The method as claimed in claim 3, wherein multiple notches are defined in the pre-connection end during the step of rounding and forming a connection end.

5. A method for making a driving bit of 50 mini-meter long, comprising:
a step of preparing: preparing an elongate bar with a polygonal cross section, the bar having two side faces and two contact faces which are adapted to be in contact with at least two insides of a hexagonal recess of a reception tool, a distance between the two contact faces being defined as X2, a distance between the two side faces being defined as Y2, wherein X2≧1.2Y2;
a step of rounding and forming a connection end: setting a first end of the bar to be a pre-connection end and a second end of the bar to be a pre-driving end, the pre-connection end being rounded to form a rounded surface so as to form the connection end;
a step of forming a driving end: milling and cutting a front end of the pre-driving end to form the driving end is adapted to drive tools, and a step of obtaining a product: a driving bit being obtained.

6. The method as claimed in claim 5, wherein multiple notches are defined in the pre-connection end during the step of rounding and forming a connection end.
